(19) United States
(12) Patent Application Publication
(10) Pub. No.: US 2025/0056318 A1
(43) Pub. Date: Feb. 13, 2025

(54) METHOD AND APPARATUS FOR DATA TRANSMISSION FOR IOT DEVICE IN WIRELESS COMMUNICATION SYSTEM

(71) Applicant: Samsung Electronics Co., Ltd., Gyeonggi-do (KR)

(72) Inventor: Kisuk KWEON, Gyeonggi-do (KR)

(21) Appl. No.: 18/799,006

(22) Filed: Aug. 9, 2024

(30) Foreign Application Priority Data
Aug. 10, 2023 (KR) 10-2023-0104989

(51) Int. Cl. H04W 28/06; H04W 68/02; H04W 76/30

(52) U.S. Cl. CPC H04W 28/06; H04W 68/02; H04W 76/30

(57) ABSTRACT

The disclosure relates to a 5G or 6G communication system for supporting a higher data transmission rate. In accordance with an aspect of the disclosure, a method of a session management function (SMF) in a communication system is provided. The method includes receiving, from a user plane function (UPF), a data notification associated with downlink data for a protocol data unit (PDU) session, identifying whether the PDU session is in a suspend mode, in case that the PDU session is in the suspend mode, transmitting, to an access and mobility management function (AMF), a Namf_MT_EnableUEReachability request message, and receiving, from the AMF, a Namf_MT_EnableUEReachability response message based on the Namf_MT_EnableUEReachability request message.

### CROSS-REFERENCE TO RELATED APPLICATION(S)

This application is based on and claims priority under 35 U.S.C. § 119 to Korean Patent Application No. 10-2023-0104989, filed on Aug. 10, 2023 in the Korean Intellectual Property Office, the disclosure of which is incorporated herein by reference in its entirety.

### BACKGROUND

### 1. Field

The disclosure relates generally to a wireless communication system and, more particularly, to a method and an apparatus for data transmission for an Internet of things (IoT) device.

### 2. Description of Related Art

Fifth generation (5G) mobile communication technologies define broad frequency bands such that high transmission rates and new services are possible. Such technologies may be implemented not only in “sub 6 gigahertz (GHz)” bands, such as 3.5 GHZ, but also in “above 6 GHz” bands, referred to as millimeter wave (mmWave), including 28 GHz and 39 GHz. In addition, sixth generation (6G) mobile communication technologies (referred to as “Beyond 5G” systems) may be implemented in terahertz (THz) bands (e.g., 95 GHz to 3 THz bands) in order to accomplish transmission rates fifty times faster than 5G mobile communication technologies and ultra-low latencies one-tenth of 5G mobile communication technologies.

At the onset of 5G mobile communication technology development, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multi input multi output (MIMO) for mitigating radio-wave path loss and increasing radio-wave transmission distances in mmWave. In addition, supporting numerologies (e.g., operating multiple subcarrier spacings) for efficiently utilizing mm Wave resources and dynamic operation of slot formats, initial access technologies for supporting multi-beam transmission and broadbands, definition and operation of bandwidth part (BWP), new channel coding methods such as a low density parity check (LDPC) code for large amounts of data transmission and a polar code for highly reliable transmission of control information, layer two (L2) pre-processing, and network slicing for providing a dedicated network specialized to a specific service are also being used to support services and to satisfy performance requirements.

There are discussions regarding improvement and performance enhancement of initial 5G mobile communication technologies in view of services to be supported by 5G mobile communication technologies, and there has been physical layer standardization regarding technologies such as vehicle-to-everything (V2X) technologies for aiding driving determination by autonomous vehicles based on information regarding positions and states of vehicles transmitted by the vehicles and for enhancing user convenience, new radio-unlicensed (NR-U) technologies aimed at system operations conforming to various regulation-related requirements in unlicensed bands, new radio (NR) user equipment (UE) power saving technologies, non-terrestrial network (NTN) technologies, which are UE-satellite direct communication technologies for providing coverage in an area in which communication with terrestrial networks is unavailable, and positioning technologies.

Moreover, there has been standardization in air interface architecture/protocol regarding technologies such as industrial IoT (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (e.g., 2-step random access channel (RACH) for NR). There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, connected devices will be connected to communication networks, and it is expected that enhanced functions and performances of 5G mobile communication systems and integrated operations of connected devices will be necessary. To this end, new research is scheduled in connection with extended reality (XR) for efficiently supporting augmented reality (AR), virtual reality (VR), and mixed reality (MR). 5G performance improvement and complexity reduction may be accomplished by utilizing artificial intelligence (AI) and machine learning (ML), AI service support, metaverse service support, and drone communication.

Furthermore, such development of 5G mobile communication systems will serve as a basis for developing new waveforms for providing coverage in THz bands of 6G mobile communication technologies, multi-antenna transmission technologies such as full dimensional multiple input multiple output (FD-MIMO), array and large-scale antennas, metamaterial-based lenses and antennas for improving coverage of THz band signals, high-dimensional space multiplexing technology using orbital angular momentum (OAM), reconfigurable intelligent surface (RIS) technology, full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

The disclosure provides a method and an apparatus for effectively providing a communication service with a device using no battery power or operating at low power in a wireless communication system.

In addition, the disclosure provides a method and an apparatus for transmitting data to a cellular IoT (CIoT) device in a communication environment in which CIoT devices are managed in a wireless communication system.

In accordance with an aspect of the disclosure, a method of a session management function (SMF) in a communication system is provided. The method includes receiving, from a user plane function (UPF), a data notification associated with a downlink data for a protocol data unit (PDU) session, identifying whether the PDU session is in a suspend mode, in case that the PDU session is in the suspend mode, transmitting, to an access and mobility management function (AMF), a Namf_MT_EnableUEReachability request message, and receiving, from the AMF, a Namf_MT_EnableUEReachability response message based on the Namf_MT_EnableUEReachability request message.

In accordance with an aspect of the disclosure, an SMF entity in a communication system is provided. The SMF entity includes a transceiver, and at least one processor coupled with the transceiver and configured to receive, from a UPF, a data notification associated with downlink data for a PDU session, to identify whether the PDU session is in a suspend mode, in case that the PDU session is in the suspend mode, to transmit, to an AMF, a Namf_MT_EnableUEReachability request message, and to receive, from the AMF, a Namf_MT_EnableUEReachability response message based on the Namf_MT_EnableUEReachability request message.

According to an embodiment of the disclosure, an apparatus and a method for effectively providing a service in a wireless communication system can be provided.

### BRIEF DESCRIPTION OF THE DRAWINGS

The above and other aspects, features, and advantages of embodiments of the disclosure will be more apparent from the following description taken in conjunction with the accompanying drawings, in which:

FIG. 1 is a diagram illustrating a structure of a 5G network, according to an embodiment;

FIG. 2 is a diagram illustrating a network triggered service request procedure, according to an embodiment;

FIG. 3 is a diagram illustrating a connection resume procedure for transmitting mobile terminated (MT) data to a UE in a connection management (CM)-IDLE with a connection suspend state, according to an embodiment;

FIG. 4 is a diagram illustrating a configuration of a UE, according to an embodiment; and

FIG. 5 is a diagram illustrating a configuration of a base station or a network entity, according to an embodiment of the disclosure.

### DETAILED DESCRIPTION

Embodiments of the disclosure are described in detail with reference to the accompanying drawings. The same or similar components may be designated by the same or similar reference numerals although being illustrated in different drawings. In addition, a detailed description of known functions or configurations that may make the subject matter of the disclosure unclear will be omitted.

In describing the embodiments of the disclosure, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more central processing units (CPUs) within a device or a security multimedia card.

As used herein, each of such phrases as “A and/or B,” “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. Such terms as “a first,” “a second,” “the first,” and “the second” may be used to simply distinguish a corresponding element from another, and does not limit the elements in other aspect (e.g., importance or order).

Herein, a base station (BS) is an entity that allocates resources to terminals, and may be at least one of a Node B, a BS, an eNode B (eNB), a gNode B (gNB), a wireless access unit, a BS controller, and a node on a network. A terminal may include a UE, a mobile station (MS), a cellular phone, a smartphone, a computer, or a multimedia system capable of performing a communication function. Furthermore, embodiments of the disclosure, as described below, may also be applied to other communication systems having similar technical backgrounds or channel types. In addition, based on determinations by those skilled in the art, embodiments may be applied to other communication systems through some modifications without significantly departing from the scope of the disclosure.

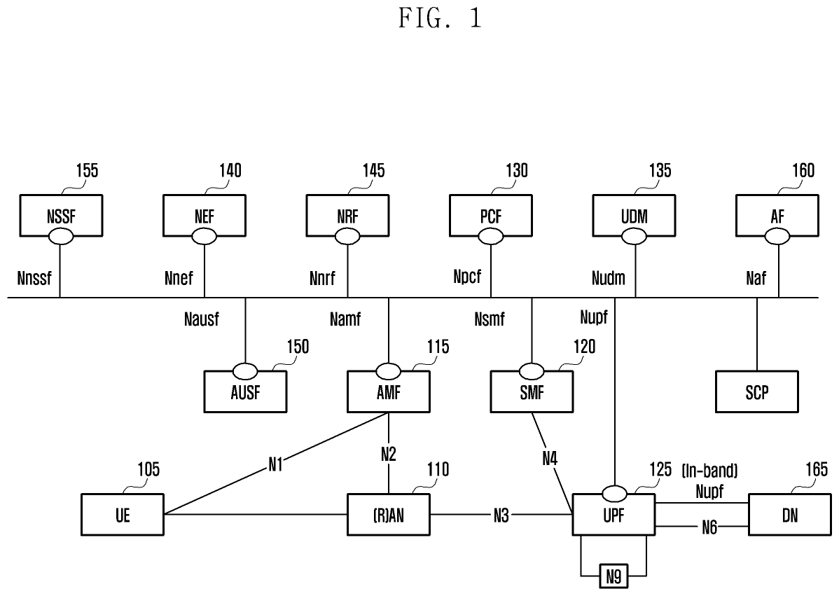

The network technology used in the disclosure may refer to the standards (e.g., TS 23.501, TS 23.502, TS 23.503, etc.) defined by the international telecommunication union (ITU) or 3rd Generation Partnership Project (3GPP), and each of the components included in the network architecture of FIG. 1 may be a physical entity or may be software that performs an individual function or hardware combined with software. Reference numerals shown in the form Nx, such as N1, N2, N3, . . . , and the like, indicate interfaces known between network functions (NFs) in a 5G core network (5GC), and a related description may refer to the standard (TS 23.501) and a detailed description is omitted.

Herein, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

Herein, some of terms and names defined in the 3GPP standards may be used for the sake of descriptive convenience. However, the disclosure is not limited by these terms and names, and may be applied in the same way to systems that conform other standards.

FIG. 1 is a diagram illustrating a configuration of a wireless communication system, according to an embodiment. FIG. 1 exemplifies a configuration of a 5G system.

Referring to FIG. 1, a 5G network may include network entities (NEs) and NFs to be described in greater detail below.

A (radio) access network ((R)AN) 110 is an entity for performing radio resource allocation of a UE 105, and may be at least one of an eNB, a Node B, a BS, a next generation radio access network (NG-RAN), a 5G access network (5G-AN), 5G new radio (5G NR), a radio access unit, a base station controller, or a node on a network.

A terminal may include a UE 105, a next generation UE (NG UE), a MS, a cellular phone, a smartphone, a computer, an IoT device, or a multimedia system capable of performing a communication function.

In addition, hereinafter, although embodiments disclosed herein will be described with reference to a 5G system as an example, the embodiments may be applied to other communication systems having a similar technical background. Furthermore, the embodiments disclosed herein may be applied to other communication systems through some modifications without significantly departing from the scope of the disclosure, as determined by those skilled in the art having technical knowledge.

As a wireless communication system evolves from a 4G system to a 5G system, a next-generation (NG) core or 5G core (5GC) network corresponding to a new core network (CN) is defined. The new core network virtualizes all existing NEs into NFs. According to an embodiment, a network function may refer to an NE, a network component, and a network resource.

According to an embodiment, a 5GC may include NFs illustrated in FIG. 1. The 5GC is not limited to the example of FIG. 1 and may include a greater number of NFs or a smaller number of NFs than those illustrated in FIG. 1.

An AMF 115 may be an NF for managing the access and mobility of the UE 105. For example, the AMF 115 may perform a network function such as registration, connection, reachability, mobility management, access identification, authentication, and mobility event generation of the UE 105.

An SMF 120 may be a network function for managing a packet data network (PDN) connection provided to the UE 105. The PDN connection may be referred to as a PDU session. For example, the SMF 120 may perform a session management function through session establishment, modification, or releasing, and maintaining of a tunnel between the UPF 125 and the RAN 110, a function of allocating and managing an Internet protocol (IP) address of the UE 105, and a network function such as selection and control of the user plane, traffic processing control in the UPF 125, and a charge data collection control.

A policy control function (PCF) 130 may be a network function that applies a service policy of a mobile communication operator to the UE 105, a charging policy, and a policy for a PDU session.

A unified data management (UDM) 135 may be a network function for storing information on a subscriber. For example, the UDM 135 may perform functions such as generating authentication information for 3GPP security, user ID processing, managing a list of NFs supporting the UE 105, and managing subscription information.

A network exposure function (NEF) 140 may be a function for providing information on the terminal to a server outside the 5G network. In addition, the NEF 140 may provide a function of providing information necessary for providing a service to the 5G network and storing the information in a UDR.

A UPF 125 may be a function that serves as a gateway for transferring user data (PDU) to a data network (DN) 165. More specifically, the UPF 125 may perform a role of processing data so that data transmitted by the UE 105 can be transferred to an external network, or data introduced from the external network can be transferred to the UE 105. For example, the UPF 125 may perform a network function such as acting as an anchor between radio access technologies (RATs), packet routing and forwarding, packet inspection, application of user plane policy, creating a traffic usage report, or buffering.

A network repository function (NRF) 145 may perform a function of storing profiles of NFs and discovering the NFs.

An authentication server function (AUSF) 150 may perform UE authentication in a 3GPP access network and a non-3GPP access network.

A network slice selection function (NSSF) 155 may perform a function of selecting a network slice instance provided to the UE 105.

A network data analytics function (NWDAF) collects data from several NFs for the purpose of efficient management of the 5GC network. The collected data is analyzed using a machine learning (ML) model, and the analyzed result is provided back to the NFs so that each of the NFs can provide an efficient network service.

An application function (AF) 160 may perform communication with an operator network so that an external server (application server) can use a network service provided by the operator network. The AF 160 may be divided into an internal AF and an external AF according to a deploying entity. An internal AF deployed by the network operator may directly communication with NFs in the operator network. An AF deployed by a 3rd party service provider needs to go through an NEF to communicate with NFs in the operator network.

A data network (DN) 165 may be a data network in which the UE 105 transmits and receives data in order to use a service of a network provider or a 3rd party service.

The UE may include an IoT device. The IoT device may include a device using no battery power or operating with very low power, and such an IoT device may be referred to as an ambient IoT device (or an ambient IoT).

The disclosure relates to a 5G CIoT, and a method in which a 5G CIoT transmits data to a CIoT device while being in a CM_IDLE with connection suspend state (or mode).

To provide an efficient network service to the 5G CIoT device, a user plane CIoT 5GS optimization function may be provided in the 5GS. The function enables the 5G CIoT device to transmit data without performing a service request procedure in a CM-IDLE state.

To apply this function, the following conditions may be satisfied.
Both the UE and the AMF are able to provide the user plane CIoT 5GS optimization function.
The UE indicates to a UE a radio capabilities parameter that the user plane CIoT 5GS optimization can be provided.
The AMF indicates to the NG-RAN that the user plane CIoT 5GS optimization is provided to the UE.
The UE has at least one of a PDU session in active UP connection state.

In addition, upon the CM-IDLE with connection suspend procedure, the UE in the CM-IDLE with connection suspend state may perform a connection resume in CM-IDLE with suspend procedure to transmit data.

Each of the entities in the CM-IDLE with connection suspend state maintains the following states.
The UE in a state of storing access stratum (AS) information transitions to a CM-IDLE state.
The NG-RAN stores AS information, next generation application protocol (NGAP) UE association and PDU session context information.
The AMF stores other pieces of information required for NGAP UE association and UE resume, requests PDU session deactivation to the SMF, and transitions to the CM-IDLE state.

In addition, to resume the UE in the CM-IDLE with connection suspend state, when the connection resume in CM-IDLE with suspend procedure is performed, the state of each of the entities is changed as follows.
The UE transitions to a CM-CONNECTED state from the CM-IDLE state by using the stored AS information.
The NG-RAN notifies the AMF of the resume of the UE.
The AMF transitions to the CM-CONNECTED state and requests PDU session activation to the SMF.

Herein, a method is provided in which, when data to be transmitted to the UE in the CM-IDLE with connection suspend state is generated, the UE transitions to the CM-CONNECTED state by performing the connection resume procedure and receives data.

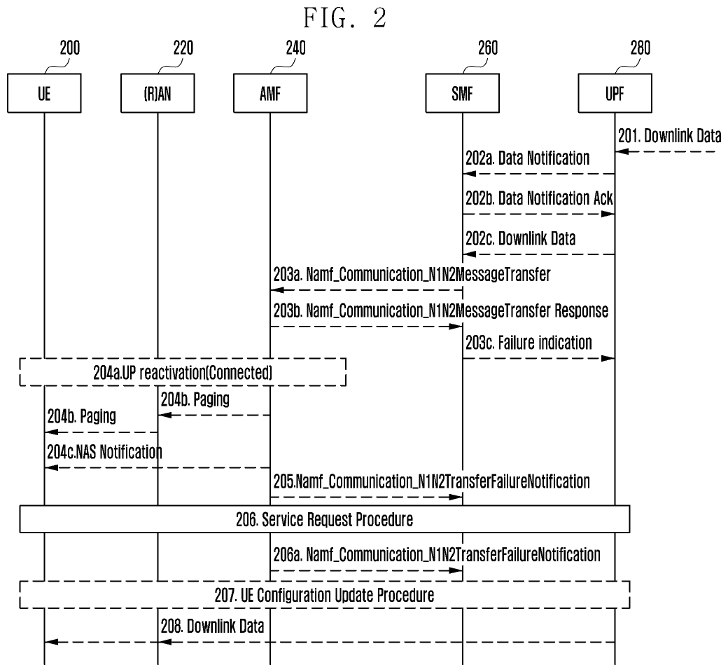

FIG. 2 is a diagram illustrating a network triggered service request procedure, according to an embodiment. More specifically, FIG. 2 illustrates a network triggered service request procedure of when data to be transmitted to the UE is generated, notifying the UE of the data generation.

At 201, a UPF 280 may receive downlink data directed to a UE PDU session that the UPF takes charge of. The UPF 280 may buffer data to the UPF 280 or transmit data to the SMF 260 upon a downlink data handling indication of the SMF 260.

At 202a, the UPF 280 may report reception of the downlink data to the SMF 260. A message for the reporting may be transmitted to the SMF 260. The message for reporting may be a data notification message. The data notification message may include N4 session ID information, information for identifying a QoS flow of downlink (DL) data, and a differentiated service code point (DSCP).

At 202b, the SMF 260 may transmit acknowledgment (ACK) of a data notification message to the UPF 280.

At 202c, when the SMF 260 indicates to the UPF 280 that the downlink data is to be buffered, the UPF 280 may transmit the downlink data to the SMF 260.

At 203a, the SMF 260 may transmit a message to the AMF 240. The message may be an Namf_Communication_N1N2MessageTransfer message. The message may include the following parameters: subscription permanent identifier (SUPI); PDU session ID; N1 SM container (SM message); and N2 SM information (QFI(s), QoS profile(s), CN N3 tunnel info, S-NSSAI, an area of validity for N2 SM information, ARP, paging policy indicator, 5QI, N1N2TransferFailure notification target address, extended buffering support).

At 203b, the AMF 240 may transmit a message in response to the message transmitted to the SMF 260. The response message may be an Namf_Communication_N1N2MessageTransfer response message.

At 203c, the SMF 260 may notify the UPF 280 of user plane setup failure through a failure indication.

At 204a, if the UE 200 is in the CM-CONNECTED state (or mode), the UE may perform a UP reactivation procedure without a paging procedure.

At 204b, the AMF 240 may perform a paging procedure to the UE 200 through a (R)AN 220. In this case, the AMF 240 may transfer the N2 SM information received from the SMF 260 at 203a to the (R)AN 220 to allow the (R)AN 220 to configure the UE context information.

At 204c, if either 3GPP access of the UE or non-3GPP access of the UE is in the CM-CONNECTED state, the AMF 240 may transmit a NAS notification to the access in the CONNECTED state to notify that the UE 200 has the downlink data to be transmitted, without performing the paging procedure.

At 205, the AMF 240 may notify the SMF 260 of paging procedure failure through a message. The message may be an Namf_Communication_N1N2Transfer failure notification message.

At 206, the UE 200 having received the paging message may perform a UE triggered service request procedure to transition to the CM-CONNECTED state from the CM-IDLE state (or mode).

At 206a, if the AMF 240 has received reject paging information from the UE 200, the AMF may notify the SMF 260 of the reception through a message. The message may be an Namf_Communication_N1N2MessageTransfer failure notification message.

At 207, the AMF 240 may initiate a UE configuration update procedure to allocate a new 5G-GUTI to the UE 200.

At 208, the downlink data may be transmitted to the UE 200 having transitioned to the CM-CONNECTED state.

The UE in the CM-IDLE with connection suspend state (or mode) also receives data through the existing network triggered service request procedure when data to be received is generated. However, to receive data, the UE in the CM-IDLE with connection suspend state needs to perform a connection resume in CM-IDLE with Suspend procedure instead of performing the UE triggered service request procedure. In addition, the UE in the CM-IDLE with connection suspend state and the NG-RAN still have (or store or establish) AS information. Accordingly, the N2 SM information does not need to be transmitted to the NG-RAN at 203a of the existing network triggered service request procedure from the SMF 260. To solve this problem, a method is provided for identifying, when receiving a data notification from the UPF 280, the state (or mode) of a PDU session to which downlink data is directed, and when the state of the PDU session is a UP suspend state (or mode) in which the UE is in the CM-IDLE with connection suspend state, transmitting a Namf_MT_EnableUEReachability request message which requests a simple paging procedure from the AMF 240 rather than the Namf_Communication_N1N2MessageTransfer message so that the UE 200 can perform a Connection Resume in CM-IDLE with suspend procedure rather than the UE triggered service request procedure.

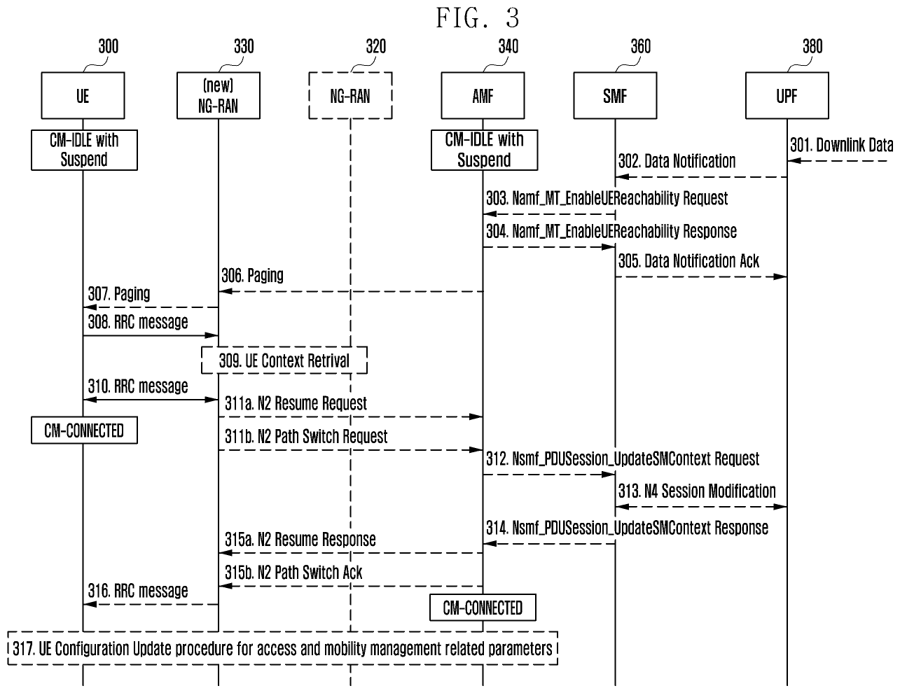

FIG. 3 is a diagram illustrating a connection resume procedure for transmitting MT data to a UE in a CM-IDLE with connection suspend state, according to an embodiment.

At 301, a UPF 380 taking charge of a PDU session in a connection suspend state may receive downlink data directed to the corresponding PDU session. The UPF 380 may buffer data to the UPF 380 or transmit data to an SMF 360 upon a downlink data handling indication of the SMF 360.

At 302, the UPF 380 may report reception of the downlink data to the SMF 360. A message for the reporting may be transmitted to the SMF 360. The message for reporting may be a data notification message. The data notification message may include N4 session ID information, information for identifying a QoS flow of DL data, and a DSCP. In addition, the UPF 380 may also identify, based on having UL N3 tunnel information of the corresponding PDU session that the corresponding PDU session is in the connection suspend state, and may also notify the SMF 360 of the same when transmitting the data notification message.

At 303, the SMF 360 may identify that a PDU session having received a data notification is in the “UP suspend” state (or mode), and transmit a message to the AMF 340. The message may be an Namf_MT_EnableUEReachability request message. The message may include PDU session ID, extended buffering support, PPI, ARP, 5QI, QFI, and the like.

At 304, the AMF 340 may transmit a response to the message to the SMF 360.

At 305, the SMF 360 may transmit acknowledgment (ACK) of the data notification message to the UPF 380.

At 306, the AMF 304 may identify that the UE 300 is in the CM-IDLE state in 3GPP access, and transmit a paging message to the NG-RAN 330.

At 307, the NG-RAN 330 may transmit a paging message for the corresponding UE 300.

At 308, the UE 300 having received the paging message in the CM-IDLE with connection suspend state may start transitioning the state of the UE to an RRC_CONNECTED or CM CONNECTED state while transmitting an RRC message (resume ID) to the NG-RAN 330. The UE 300 may transmit the Resume ID together so that the NG-RAN 330 can retrieve UE context information.

At 309, when the NG-RAN 330 in charge is changed, a new NG-RAN 330 may perform the UE context retrieval to the old NG-RAN 320.

At 310, the UE 300 and the NG-RAN 330 may perform a resume procedure and an access stratum (AS) configuration synchronization procedure. After this operation, the UE 300 may transition to the CM-CONNECTED or RRC-CONNECTED state.

At 311a and 311b, different messages may be transmitted to the AMF 340 according to a currently servicing NG-RAN and an NG-RAN when the UE is suspended are changed. If the NG-RAN is identical, 311a is performed, and when the NG-RAN is changed, 311b is performed.

At 311a, the NG-RAN 330 may transmit a message to the AMF 340. The message may be an N2 resume request message. The message may include a resume cause value and an N2 SM information value.

At 311b, the NG-RAN 330 may transmit a message to the AMF 340. The message may be an N2 path switch request message. Through this operation, a new NG-RAN 330 may retrieve a UE context value from the old NG-RAN 320.

At 312, the AMF 340 may transmit a message to the SMF 360. The message may be an Nsmf_PDUSession_UpdateSMContext request message. The message may include PDU session ID, cause, operation type, user location information, age of location information, and N2 SM information. The operation type value may be configured to “UP Resume”.

At 313, the SMF 360 may transmit a message to the UPF 380. The message may be an N4 session modification request message. The message may include AN tunnel info to be resumed and buffering on/off information.

At 314, the SMF 360 may transmit a message to the AMF 340. The message may be an Nsmf_PDUSession_UpdateSMContext response message. When new CN tunnel information is generated, the message may include new CN tunnel information.

At 315a and 315b, the AMF 340 may transmit response messages corresponding to 311a and 311b to the NG-RAN 330.

At 316, the NG-RAN 330 may transmit an RRC message to the UE 300. The message may cause reconfiguration of RRC connection based on a resume result received from the AMF 340.

At 317, the AMF 340 may initiate a UE configuration update procedure to allocate a new 5G-GUTI to the UE 300.

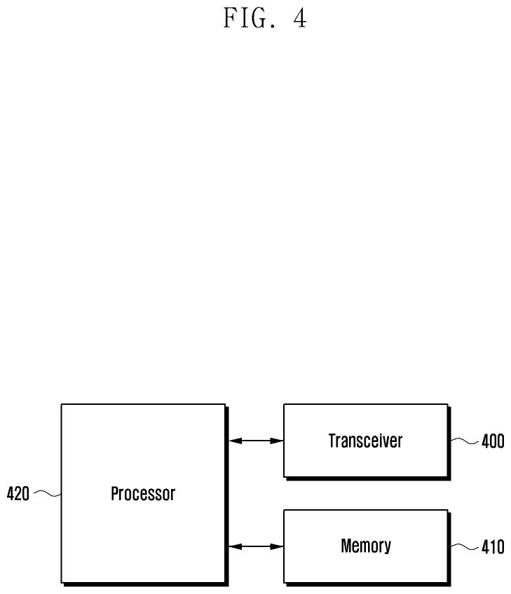

FIG. 4 is a diagram illustrating a configuration of a UE, according to an embodiment.

A UE may include a processor 420 for controlling an overall operation of the UE, a transceiver 400 including a transmitter and a receiver, and memory 410. The disclosure is not limited to the example above, and the UE may include more elements or fewer elements than the elements illustrated in FIG. 4

The transceiver 400 may transmit or receive signals to or from network entities or other UEs. The signals transmitted or received to or from the network entities may include control information and data. In addition, the transceiver 400 may receive the signals through radio channels, output the same to the processor 420, and transmit the signals output from the processor 420 through the radio channels.

The processor 420 may control the terminal to perform an operation described above. The processor 420, the memory 410, and the transceiver 400 are not necessarily required to be implemented as separate modules, and may be implemented as one element in the form such as a single chip. The processor 420 and the transceiver 400 may be electrically connected. In addition, the processor 420 may be an application processor (AP), a communication processor (CP), a circuit, an application-specific circuit, or at least one processor.

The memory 410 may store data such as a basic program, an application program, and configuration information for operation of the terminal. Specifically, the memory 410 provides data stored upon the request from the processor 420. The memory 410 may be a storage medium such as ROM, random access memory (RAM), hard discs, compact disc (CD)-ROMs, and digital versatile discs (DVDs), or a combination of storage media. In addition, there may be multiple memories 410. In addition, the processor 420 may perform above-described embodiments based on the program which is stored in the memory 410 and performs the above-described embodiments of the disclosure.

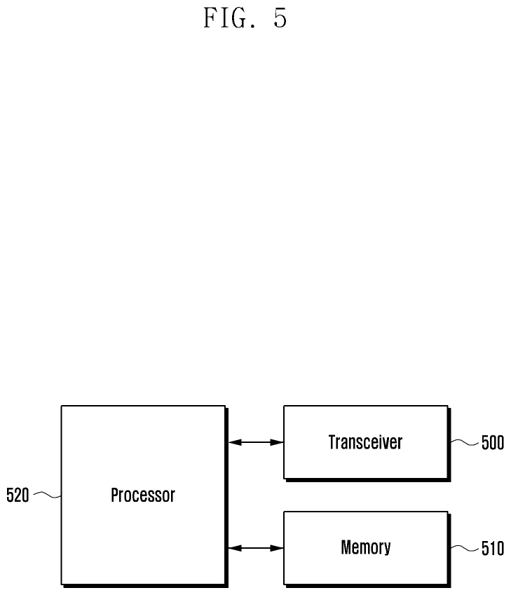

FIG. 5 is a diagram illustrating a configuration of a base station or an NE, according to an embodiment.

An NE may include a processor 520 for controlling an overall operation of the network entity, a transceiver 500 including a transmitter and a receiver, and memory 510. The disclosure is not limited to the example above, and the network entity may include more elements or fewer elements than the elements illustrated in FIG. 5.

The transceiver 500 may transmit or receive signals to or from at least one of other NEs or the UE. The signals transmitted or received to or from at least one of the other NEs or the UE may include control information and data.

The processor 520 may control the NE to perform an operation of one of the above-described embodiments. The processor 520, the memory 510, and the transceiver 500 are not necessarily required to be implemented as separate modules, and may be implemented as one element in the form such as a single chip. The processor 520 and the transceiver 500 may be electrically connected. In addition, the processor 520 may be an AP, a CP, a circuit, an application-specific circuit, or at least one processor.

The memory 510 may store data such as a basic program, an application program, and configuration information for operation of the network entity. Specifically, the memory 510 provides data stored upon the request from the processor 520. The memory 510 may be a storage medium such as ROM, RAM, hard discs, CD-ROMs, and DVDs, or a combination of storage media. In addition, there may be multiple memories 510. In addition, the processor 520 may perform the above-described embodiments based on the program which is stored in the memory 510 and performs the above-described embodiments of the disclosure.

It should be noted that the above-described configuration diagrams, illustrative diagrams of control/data signal transmission methods, illustrative diagrams of operation procedures, and structural diagrams are not intended to limit the scope of the disclosure. That is, all constituent elements, entities, or operation steps described in the embodiments of the disclosure should not be construed as being essential for the implementation of the disclosure, and the disclosure may be implemented without impairing the essential features of the disclosure by including only some constituent elements. Also, the above respective embodiments may be employed in combination, as necessary. For example, the methods proposed in the disclosure may be partially combined with each other to operate a network entity and a terminal.

The above-described operations of a base station or terminal may be implemented by providing any unit of the base station or terminal device with a memory device storing corresponding program codes. That is, a controller of the base station or terminal device may perform the above-described operations by reading and executing the program codes stored in the memory device by means of a processor or central processing unit (CPU).

Various units or modules of an entity, a base station device, or a terminal device may be operated using hardware circuits such as complementary metal oxide semiconductor-based logic circuits, firmware, or hardware circuits such as combinations of software and/or hardware and firmware and/or software embedded in a machine-readable medium. For example, various electrical structures and methods may be implemented using transistors, logic gates, and electrical circuits such as application-specific integrated circuits.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a ROM, an electrically erasable programmable read only memory (EEPROM), a magnetic disc storage device, a CD-ROM, DVDs, or other type optical storage devices, or a magnetic cassette. Alternatively, any combination of some or all of them may form a memory in which the program is stored. In addition, a plurality of such memories may be included in the electronic device.

In addition, the programs may be stored in an attachable storage device which can access the electronic device through communication networks such as the Internet, Intranet, local area network (LAN), wide LAN (WLAN), and storage area network (SAN) or a combination thereof. Such a storage device may access the electronic device via an external port. Also, a separate storage device on the communication network may access a portable electronic device.

An element described herein is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

It will be apparent to those skilled in the art that other variants based on the technical idea of the disclosure may be implemented. Also, the above respective embodiments may be employed in combination, as necessary. As an example, the methods proposed in the disclosure may be partially combined with each other to operate a base station and a terminal. Moreover, although the above embodiments have been described based on the 5G or NR system, other variants based on the technical idea of the embodiments may also be implemented in other communication systems such as LTE, LTE-A, or LTE-A-Pro systems.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

What is claimed is:

1. A method of a session management function (SMF) in a communication system, the method comprising:
receiving, from a user plane function (UPF), a data notification associated with downlink data for a protocol data unit (PDU) session;
identifying whether the PDU session is in a suspend mode;
in case that the PDU session is in the suspend mode, transmitting, to an access and mobility management function (AMF), a Namf_MT_EnableUEReachability request message; and
receiving, from the AMF, a Namf_MT_EnableUEReachability response message based on the Namf_MT_EnableUEReachability request message.

2. The method of claim 1, further comprising:
in case that the PDU session is not in the suspend mode, transmitting, to the AMF, a Namf_Communication_N1N2MessageTransfer message; and
receiving, from the AMF, a Namf_Communication_N1N2MessageTransfer response message based on the Namf_Communication_N1N2MessageTransfer message.

3. The method of claim 1, wherein the suspend mode of the PDU session corresponds to a user plane (UP) suspend.

4. The method of claim 2, wherein N2 session management (SM) information is not included in the Namf_MT_EnableUEReachability request message, and
wherein the N2 SM information is included in the Namf_Communication_N1N2MessageTransfer message.

5. The method of claim 1, wherein the Namf_MT_EnableUEReachability request message is transmitted in case that the N2 SM information is not to be delivered.

6. The method of claim 1, wherein the Namf_MT_EnableUEReachability request message is used to trigger a paging procedure without providing N2 SM information.

7. The method of claim 6, wherein, in case that the paging procedure is triggered based on the Namf_MT_EnableUEReachability request message, a connection resume in connection management (CM)-IDLE with suspend procedure is initiated rather than a UE triggered service request procedure.

8. A session management function (SMF) entity in a communication system, the SMF entity comprises:
a transceiver; and
at least one processor coupled with the transceiver and configured to:
receive, from a user plane function (UPF), a data notification associated with downlink data for a protocol data unit (PDU) session,
identify whether the PDU session is in a suspend mode,
in case that the PDU session is in the suspend mode, transmit, to an access and mobility management function (AMF), a Namf_MT_EnableUEReachability request message, and
receive, from the AMF, a Namf_MT_EnableUEReachability response message based on the Namf_MT_EnableUEReachability request message.

9. The SMF entity of claim 8, wherein the at least one processor is further configured to:
in case that the PDU session is not in the suspend mode, transmit, to the AMF, a Namf_Communication_N1N2MessageTransfer message, and
receive, from the AMF, a Namf_Communication_N1N2MessageTransfer response message based on the Namf_Communication_N1N2Message Transfer message.

10. The SMF entity of claim 8, wherein the suspend mode of the PDU session corresponds to a user plane (UP) suspend.

11. The SMF entity of claim 9,
wherein N2 session management (SM) information is not included in the Namf_MT_EnableUEReachability request message, and
wherein the N2 SM information is included in the Namf_Communication_N1N2Message Transfer message.

12. The SMF entity of claim 8, wherein the Namf_MT_EnableUEReachability request message is transmitted in case that the N2 SM information is not to be delivered.

13. The SMF entity of claim 8, wherein the Namf_MT_EnableUEReachability request message is used to trigger a paging procedure without providing N2 SM information.

14. The SMF entity of claim 13, wherein, in case that the paging procedure is triggered based on the Namf_MT_EnableUEReachability request message, a connection resume in connection management (CM)-IDLE with suspend procedure is initiated rather than a UE triggered service request procedure.
